(19) United States
(12) Patent Application Publication
(10) Pub. No.: US 2023/0387460 A1
(43) Pub. Date: Nov. 30, 2023

(54) ELECTROLYTE COMPRISING CROSSLINKED POLYMER WITH DISORDERED NETWORK

(71) Applicant: Factorial Inc., Woburn, MA (US)

(72) Inventors: Jia DU, Burlington, MA (US); Dong Ren, Woburn, MA (US); Yiqing Huang, Lexington, MA (US)

(21) Appl. No.: 18/250,016

(22) PCT Filed: May 5, 2022
(86) PCT No.: PCT/US2022/027849

§ 371 Date: Apr. 21, 2023

Related U.S. Application Data
(63) Continuation-in-part of application No. 17/395,477, filed on Aug. 6, 2021.
(60) Provisional application No. 63/304,932, filed on Jan. 31, 2022.

(51) Int. Cl. H01M 10/0565

(52) U.S. Cl. CPC H01M 10/0565; H01M 2300/0082

(57) ABSTRACT

A polymer solid electrolyte includes a crosslinked polymer or copolymer with a heterogenous or disordered polymer network synthesized from one or more crosslinkers, wherein at least one crosslinker has three or more polymerizable or crosslinkable terminals. In another embodiment, the crosslinked polymer or copolymer has a polymer network with topological defects. In one embodiment, the crosslinked polymer is not over-crosslinked. An electrochemical device with the crosslinked polymer or copolymer as electrolyte exhibits an improved electrochemical and safety performance In certain embodiment, the crosslinkers include a) tri-acrylates, and tetra-acrylates; b) modified tri-acrylates and tetra-acrylates; c) silanes and siloxanes; and d) triazinane-triones.

### CROSS-REFERENCE TO RELATED APPLICATIONS

The present application claims benefit and/or priority of U.S. Ser. No. 63/304,932, filed Jan. 31, 2022 and U.S. Ser. No. 17/395,477, filed Aug. 6, 2021, the entire content of which is incorporated herein by reference into this application. Throughout this application, various references or publications are cited. Disclosures of these references or publications in their entireties are hereby incorporated by reference into the application in order to more fully describe the state of the art to which this invention pertains.

### FIELD

The present invention generally relates to various polymer solid electrolyte materials suitable for electrochemical devices such as batteries, capacitors, sensors, condensers, electrochromic elements, photoelectric conversion elements, etc.

### BACKGROUND

Battery technologies have transformed significantly over the past five decades. As the field of electrical energy storage continues to grow and be widely applied, the demand for lithium-ion battery (LIB) performance becomes higher and higher. Cycle life is pushed from thousands of cycles to a million cycles; energy density has advanced to approach 500 Wh/kg; the cost of high-performing batteries is incrementally decreasing, approaching as low as $100/Wh. With such high demand, the performance limit of current LIB system, i.e., lithium metal oxide cathode paired with a graphite anode in liquid carbonate electrolyte, is imminent and only minute improvement can be made to further its performance. However, as the energy density of LIBs become higher failure of LIBs packed with increased energy in a given space would cause more serious safety concerns.

Accompanying the rise of energy densities of lithium-ion batteries (LIBs) and the expansions of scale, finding a solution to the safety concerns of LIBs becomes more important. Safety issues existing in LIBs may arise from the use of mixed flammable solvents such as carbonate/ether, which, in the case of overcharging, short-circuiting, over-heating, etc. can lead to serious accidents from LIBs catching on fire, burning or even exploding, etc.

### SUMMARY

The present invention generally relates to various polymer solid electrolyte materials. The subject matter of the present disclosure involves, in some cases, interrelated products, alternative solutions to a particular problem, and/or a plurality of different uses of one or more systems and/or articles.

In one aspect, the present invention is generally directed to a polymer solid electrolyte containing a crosslinked polymer or copolymer with a heterogenous or disordered polymer network synthesized from one or more crosslinkers (alternatively, cross-linkers), wherein at least one crosslinker (alternatively, cross-linker) has three or more polymerizable or crosslinkable terminals.

In another aspect, the present invention is generally directed to an electrochemical device including the polymer solid electrolyte mentioned above.

In yet another aspect, the present invention is generally directed to a method of making same. In one set of embodiments, the method inculdes mixing one or more crosslinkers to form a slurry, and curing the slurry by UV curing or by thermal curing, wherein at least one crosslinker has three or more polymerizable or crosslinkable terminals. In some cases, the crosslinker with three or more terminals includes a) tri-acrylates, and tetra-acrylates; b) modified tri-acrylates and tetra-acrylates; c) silanes and siloxanes; and d) triazinane-triones. In some cases, the slurry is formed with a solvent.

In another aspect, the present invention encompasses methods of making or using one or more of the embodiments described herein, for example, polymer solid electrolyte materials.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 illustrates the capacity retention test curves of certain embodiments of the disclosure.

FIG. 2 illustrates the capacity retention test curves of certain embodiments of the disclosure.

FIG. 3 illustrates the capacity retention test curves of certain embodiments of the disclosure.

FIG. 4 illustrates the capacity retention test curves of certain embodiments of the disclosure.

FIG. 5 illustrates the electrochemical stability test curves of certain embodiments of the disclosure.

FIG. 6 is a diagram for a typical external short circuit test.

### DETAILED DESCRIPTION

The present invention generally relates various polymer solid electrolyte suitable for various electrochemical devices. Certain aspects include a polymer, a plasticizer, and an electrolyte salt. In some cases, the electrolyte may include a crosslinked polymer or copolymer synthesized from one or more crosslinkers, wherein at least one crosslinker has three or more polymerizable or crosslinkable terminals.

In certain embodiments, the crosslinker with three or more polymerizable or crosslinkable terminals has a formula as follows:

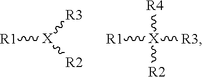

wherein X is C, Si, N, P, B, or a cyclic ring,
R1, R2, and R3 are polymerizable or crosslinkable terminals covalently connected to X directly or via a spacer chain or group. R1, R2, R3 and their spacer chains or groups may be same or different from each other.

In certain embodiments, the three or more polymerizable or crosslinkable terminals (R1, R2, R3 and R4) are independently selected from the group consisting of C₂₋₂₀ alkenyl, C₂₋₂₀ alkynyl, epoxy, amino, hydroxyl, carboxylic acid, or any substituted form thereof.

In certain embodiments, the crosslinker with three or more polymerizable or crosslinkable terminals is a tri-acrylate, tetra-acrylate, modified tri-acrylate, modified tetra-acrylate, silane, siloxane or triazinane-trione (triazine-trione).

In certain embodiments, the crosslinker with three or more terminals has a formula selected from the group consisting of:

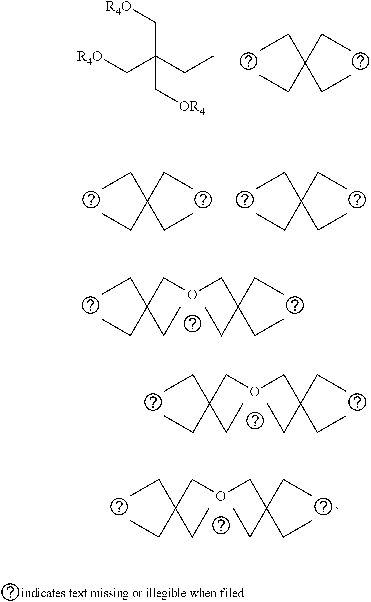

wherein R₄ and R₅ are independently selected from the group consisting of:

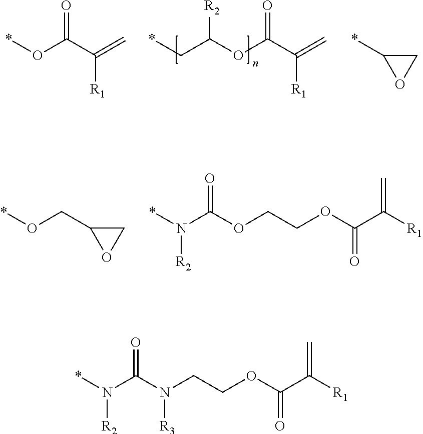

wherein R₁, R₂, R₃, R₆ are each independently selected from the group consisting of hydrogen, methyl, ethyl, phenyl, methyl phenyl, benzyl, acryl, epoxy ethyl, isocyanate, cyclic carbonate, lactone, lactam, and vinyl, wherein n is an integer between 0 and 50,000 and * indicates a point of attachment.

In certain embodiments, the crosslinker has a formula of:

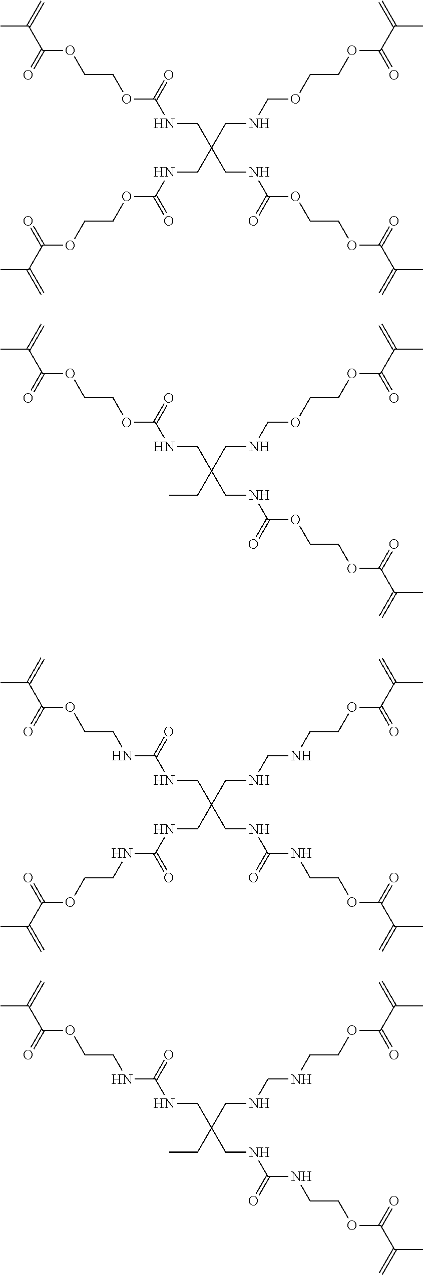

In certain embodiments, modified tri-acrylates and tetra-acrylates include tri-acrylates and tetra-acrylates with substituted groups such as —CN, —SO₂H, —CO₂H, —CO₂—, F, Cl, Br, or I.

In certain embodiments, the crosslinker with three or more terminals is a silane or siloxane.

In one embodiment, one or more of the crosslinkers or the spacer chains or groups contain a structure including without limitation —O—, —NR^{c}—, —S—, —C(═O)—, —C(═O)O—, —C(═O)NR^{c}—, —C(═O)S—, —OC(═O)O—, —NR^{c}C(═O)O—, —NR^{c}C(═O)NR^{c}—, —S(═O)—, —S(═O)₂—, —OS(═O)₂—, —OS(═O)₂O—, —NR^{c}S(═O)₂—, —NR^{c}S(═O)₂NR^{c}—, —OS(═O)₂NR^{c}—, C₁₋₆ alkylenyl, C₂₋₆ alkenylenyl, C₂₋₆ alkynylenyl, C₆₋₁₄ arylenyl, 5- to 14-membered heteroarylenyl, C₃₋₁₀ carbocyclenyl, or 3- to 10-membered heterocyclenyl, wherein the alkylenyl, alkenylenyl, alkynylenyl, arylenyl, heteroarylenyl, carbocyclenyl, or heterocyclenyl is optionally substituted with halogen, —CN, —NO₂, C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₆₋₁₄ aryl, 5- to 14-membered heteroaryl, C₃₋₁₀ carbocyclyl, 3- to 10-membered heterocyclyl, —SR^{b}, —S(═O)R^{a}, —S(═O)₂R^{a}, —S(═O)₂OR^{b}, —S(═O)₂NR^{c}R^{d}, —NR^{c}R^{d}, —NR^{c}S(═O)₂R^{a}, —NR^{c}S(═O)₂R^{a}, —NR^{c}S(═O)₂OR^{b}, —NR^{c}S(═O)₂NR^{c}R^{d}, —NR^{b}C(═O)NR^{c}R^{d}, —NR^{b}C(═O)R^{a}, —NR^{b}C(═O)OR^{b}, —OR^{b}, —OS(═O)₂R^{a}, —OS(═O)₂OR^{b}, —OS(═O)₂NR^{c}R^{d}, —OC(═O)R^{a}, —OC(═O)OR^{b}, —OC(═O)NR^{c}R^{d}, —C(═O)R^{a}, —C(═O)OR^{b}, or —C(═O)NR^{c}R^{d}; wherein R^{a}, R^{b}, R^{c}, and R^{d} are independently C₁₋₆ alkyl, C₁₋₆ haloalkyl, C₁₋₆ hydroxyalkyl, C₁₋₆ aminoalkyl, C₂₋₆ alkenyl, C₂₋₆ alkynyl, C₃₋₁₀ carbocyclyl, 3- to 10-membered heterocyclyl, C₆₋₁₄ aryl, or 5- to 14-membered heteroaryl, wherein the alkyl, haloalkyl, hydroxyalkyl, aminoalkyl, alkenyl, alkynyl, carbocyclyl, heterocyclyl, aryl, and heteroaryl is optionally substituted with one or more oxo, halogen, —CN, —OH, —OMe, —NH₂, —C(═O)Me, —C(═O)OH, —C(═O)OMe, C₁₋₆ alkyl, or C₁₋₆ haloalkyl.

In one embodiment, Re and R d , together with the hetero atom (such as N, O, S, P), form a 3- to 10-membered heterocyclyl, wherein the heterocyclyl is optionally substituted with one or more oxo, halogen, —CN, —OH, —OMe, —NH₂, —C(═O)Me, —C(═O)OH, —C(═O)OMe, C₁₋₆ alkyl, or C₁₋₆ haloalkyl.

In certain embodiments, one of the crosslinkers or the spacer chains or groups comprise a structure of —XC(═O)CR³═C(R⁴)₂, wherein X is independently O or NR^{e}, R^{e} is independently H or C₁₋₆ alkyl, and each R³ and R⁴ is independently H or C₁₋₆ alkyl.

In certain embodiments, one of the crosslinkers comprises one or more functional groups including without limitation:

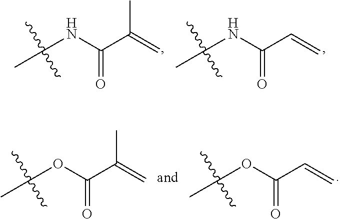

In certain embodiments, the crosslinker with one or more functional groups includes without limitation:

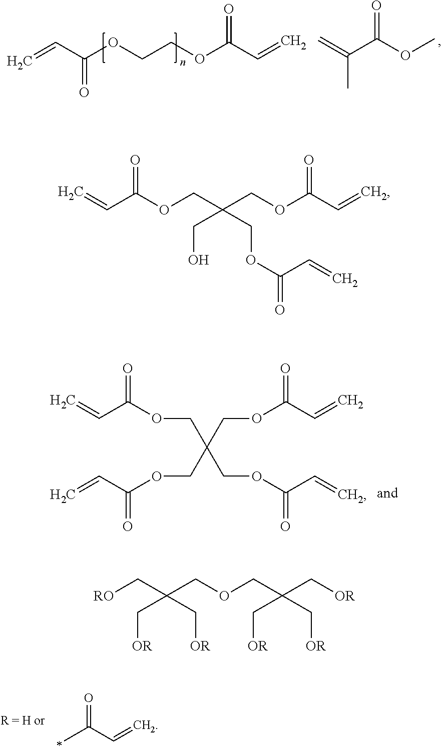

In one embodiment, the crosslinker with one or more functional groups is a monomer for ring opening polymerization and has a formular as follows:

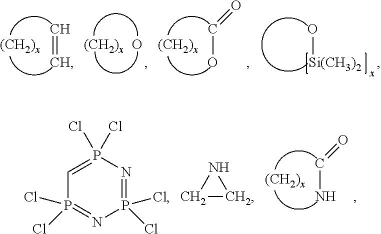

and any substituted form thereof, wherein x is an integer ranging from 1 to 1000.

In one embodiment, the monomer for ring opening polymerization includes:

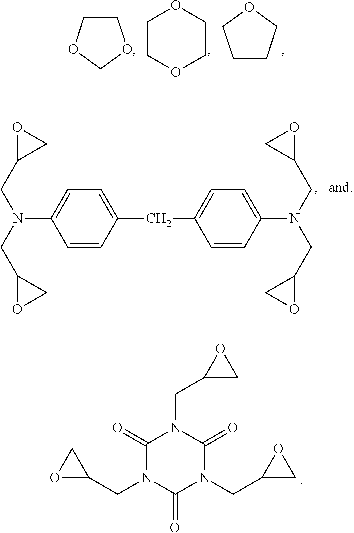

In one embodiment, the monomer for ring opening polymerization comprises an unsubstituted or substituted oxirane ring, oxetane ring, furan ring, aziridine ring, and azetidine ring.

In addition, certain embodiments are directed to compositions for use with polymer solid electrolytes, batteries, or other electrochemical devices including same, and methods for producing same. In some cases, the incorporation of vinyl and/or allyl functional groups with UV crosslinking or thermal crosslinking can be used to improve various electrochemical performance, especially when the crosslinker has polymerizable or crosslinkable terminals, such as vinyl and allyl, in at least three directions of the chemical structure of the crosslinker (i.e. the crosslinker has three crosslinkable terminals), the electrochemical performance can be improved more obviously. In certain embodiments, some polymer solid electrolytes may be used to achieve safer, longer-life lithium batteries. The electrolytes may exhibit better ionic conductivity. These properties may benefit charging/discharging rate performances. In addition, the improved decomposition potential of the polymer materials may enhance stability of a solid state electrolyte, leading to lithium batteries with a longer-life and/or higher voltage.

In one aspect, the present disclosure is generally directed to an electrochemical cell, such as a battery, including a polymer solid electrolyte material as disclosed herein. In certain embodiments, the battery is an LIB, such as a lithium-ion solid-state battery. The electrochemical cell may include an anode, a cathode, and/or a separator. Many of these are available commercially. In one embodiment, a polymer solid electrolyte material may be used as the electrolyte of the electrochemical cell, alone and/or in combination with other electrolyte materials.

One aspect, for instance, is generally directed to solid electrolytes including certain polymers that can be used within electrochemical devices, for example, batteries such as LIBs. Such electrochemical devices typically comprise one or more cells, each including an anode, a cathode, and an electrolyte. In comparison to liquid electrolytes, solid polymer electrolytes may be lightweight and provide good adhesiveness and processing properties. This may result in safer batteries and other electrochemical devices. In some cases, the polymer electrolyte may allow the transport of ions, e.g., without allowing transport of electrons. The polymer electrolyte may include a polymer and an electrolyte salt. The electrolyte salt may be, for example, a lithium salt, or other salts such as those discussed herein.

Certain embodiments of the invention are generally directed to solid electrolytes having relatively high ionic conductivity and electrical properties, e.g., decomposition potential. In some cases, for example, a polymer may exhibit improved properties due to the addition of at least three crosslinkable terminals at three directions and no poly (ethylene oxide) polymer chain (i.e. free of poly (ethylene oxide) polymer chain) in the crosslinker or crosslinked polymer.

In some embodiments, polymerizable and crosslinkable terminals (alternatively groups) include without limitation C₂₋₂₀ alkenyl, C₂₋₂₀ alkynyl, epoxy, amino, hydroxyl, carboxylic acid, or any substituted form thereof. In certain embodiment, they are vinyl and/or allyl.

In addition, in one set of embodiments, the terminals or groups such as vinyl and/or allyl may be crosslinked together. For example, such functional groups may be crosslinked using UV light, at an elevated temperature (e.g., between 20° C. and 100° C.), in the presence of an initiator, or other methods including those described herein. In some cases, the incorporation of three crosslinkable terminals leads to a disorganized or disordered network, resulting in improved electrochemical performances, or the like, such as relatively high ionic conductivities, decomposition voltages.

The crosslink density is generally defined as the number of crosslinks per unit volume in a polymer network. In certain embodiments, the crosslink density is measured by the numbers of crosslinkable terminals or crosslinks per unit volume in the polymer or matrix either before or after crosslinking. In certain embodiments, the crosslink density is measured by the numbers of crosslinkable terminals or crosslinks from crosslinkers with at least three terminals in at least three directions in the polymer or matrix either before or after crosslinking. In certain embodiments, the crosslink density is measured by the numbers of crosslinks from crosslinkers with four terminals toward four directions per unit volume in the crosslinked polymer or matrix. In certain embodiments, the crosslink density is measured by the numbers of crosslinkable terminals or crosslinks from crosslinkers with at least four terminals in at least four directions in the polymer or matrix either before or after crosslinking. In certain embodiments, the crosslink density is indirectly measured by the weight or molar percentage of crosslinkers in the system before or after crosslinking. In certain embodiments, the crosslink density is indirectly measured by the weight or molar percentage of crosslinkers with at least three terminals in the system either before or after crosslinking. In certain embodiments, the crosslink density is indirectly measured by the weight or molar percentage of crosslinkers with at least four terminals in the system either before or after crosslinking. In one embodiment, the polymer solid electrolyte has a crosslink density corresponding to a crosslinker with a weight percentage of between 0.1% and 30 wt % in the total weight of polymer solid electrolyte.

In some cases, polymer solid electrolytes such as those described herein may provide certain beneficial properties, such as surprisingly high ionic conductivities, compared to other solid electrolytes. For example, the polymer solid electrolyte may exhibit ionic conductivities of at least 0.01 mS/cm, at least 0.05 mS/cm, at least 0.10 mS/cm, at least 0.15 mS/cm, at least 0.20 mS/cm, at least 0.25 mS/cm , at least 0.30 mS/cm, at least 0.35 mS/cm, at least 0.40 mS/cm, at least 0.45 mS/cm, at least 0.50 mS/cm, at least 0.55 mS/cm, at least 0.60 mS/cm, at least 0.65 mS/cm, at least 0.70 mS/cm, at least 0.75 mS/cm, at least 0.80 mS/cm, at least 0.91 mS/cm, at least 0.97 mS/cm, at least 1 mS/cm, at least 1.04 mS/cm, at least 1.05 mS/cm, at least 1.23 mS/cm, at least 1.26 mS/cm, at least 1.31 mS/cm, at least 1.33 mS/cm, at least 1.52 mS/cm, at least 1.80 mS/cm, or at least 2.0 mS/cm. In one embodiment, for example, the polymer solid electrolyte has ionic conductivity in between 0.01 mS/cm and 10 mS/cm at room temperature.

In some cases, the crosslinker has at least three crosslinkable terminals, enabling it to crosslink from three or more terminals rather than from two terminals of a linear crosslinker. Without wishing to be bound by any theory, ionic conductivity is improved because the crosslinked polymer network possesses a unique 3D crosslinking structure which allows and promotes ion transportation. In one embodiment, such unique 3D crosslinking structure is a polymer network with a heterogeneous or disordered crosslinking structure, wherein crosslinking points and polymer chains form tunnels and channels as a pathway for movements of ions. In one embodiment, the tunnels and channels in the heterogenous crosslinking structure possess spatial configurations which match the hydrodynamic sizes of ions during transportation. In another embodiment, the unique 3D crosslinking structure is a polymer network with topological defects such as loops, dangling chains, multiple connections between two crosslink points, and chain entanglements. In one embodiment, the topological defects form tunnels and channels as a pathway for movements of ions. In one embodiment, the topological defects in the crosslinked polymer network match the hydrodynamic sizes of ions.

In one embodiment, the heterogeneity of such heterogeneous or disordered crosslinking structure is measured in view of or correlated with the weight or molar percentage of the crosslinker with at least three terminals. In one embodiment, the heterogeneity is measured in view of or correlated with the weight or molar percentage of the crosslinker with at least three terminals in consideration of a coefficient indicating spatial contribution of these terminals. For example, heterogeneity may be calculated as k*A, wherein A is the weight or molar percentage and k is the coefficient. In one embodiment, k has a value of 3 and 4 for crosslinkers with 3 and 4 terminals, respectively. In one embodiment, the concentration of the topological defects is measured in view of or correlated with the weight or molar percentage of the crosslinker with at least three terminals.

In one embodiment, the crosslinked polymer network does not include poly (ethylene oxide) polymer chain. In one embodiment, multiple crosslinkers can maintain high ionic conductivity of the polymer solid electrolyte, while minimizing the crosslinker amount.

In one embodiment, the present invention also discloses a method of measuring the 3D crosslinking structure in a polymer solid electrolyte. In one embodiment, the method comprises:
1) placing into a container a polymer solid electrolyte comprising an electrolyte salt embedded in a 3D crosslinking structure, wherein the container contains a solvent for extracting the electrolyte salt;
2) extracting the electrolyte salt from polymer solid electrolyte while maintaining the 3D crosslinking structure uncollapsed, resulting in an article free of the electrolyte salt;
3) removing the solvent from the article while maintaining the 3D crosslinking structure uncollapsed, leading to a dried article; and
4) measuring specific surface area such as BET and pore size distribution of the dried article based on a nitrogen adsorption method, thereby obtaining the 3D crosslinking structure comprising the specific surface area and pore size distribution.

In one embodiment, the container for extraction is kept at a temperature to maintain the 3D crosslink structure unfolded. In one embodiment, the temperature is at least 20° C. lower than the glass transition temperature of the crosslinked polymer, which may be measured by differential scanning calorimetry (DSC), dynamic mechanical analysis, or any other equivalent techniques. In one embodiment, the solvent is pre-selected so that it can dissolve the electrolyte salt but not affect the morphology of the 3D crosslinked polymer.

In one embodiment, the present invention provides A polymer solid electrolyte comprising an electrolyte salt and a crosslinked polymer network synthesized from one or more crosslinkers, wherein at least one crosslinker has three or more polymerizable or crosslinkable terminals.

In one embodiment, the present invention provides a polymer solid electrolyte comprising an electrolyte salt and a crosslinked polymer with a heterogenous or disordered polymer network synthesized from one or more crosslinkers, wherein at least one crosslinker has three or more polymerizable or crosslinkable terminals.

In one embodiment, the present invention provides a polymer solid electrolyte comprising an electrolyte salt and a crosslinked polymer with topological defects synthesized from one or more crosslinkers, wherein at least one crosslinker has three or more polymerizable or crosslinkable terminals.

In one embodiment, the crosslinker with three or more polymerizable or crosslinkable terminals has a concentration of no less than 0.1 wt % and no more than 20 wt % in the electrolyte. In one embodiment, the one or more crosslinkers have a concentration of no less than 0.1 wt % and no more than 30 wt % in the electrolyte. In one embodiment, the crosslinked polymer in the polymer solid electrolyte is not over-crosslinked. In one embodiment, the crosslinked polymer is obtained from a composition comprising the crosslinkers at a concentration of no less than 0.1 wt % and no more than 30 wt %. In one embodiment, the crosslinked polymer is obtained from a composition comprising the crosslinker with three or more polymerization or crosslinkable terminals at a concentration of no less than 0.1 wt % and no more than 20 wt %.

In one embodiment, at least one of the one or more crosslinkers has an electron-donating group, which promotes ion transport in the electrolyte.

In one embodiment, the electron-donating group is an amide.

In one embodiment, the crosslinker with three or more polymerizable or crosslinkable terminals has a formula selected from the group consisting of:

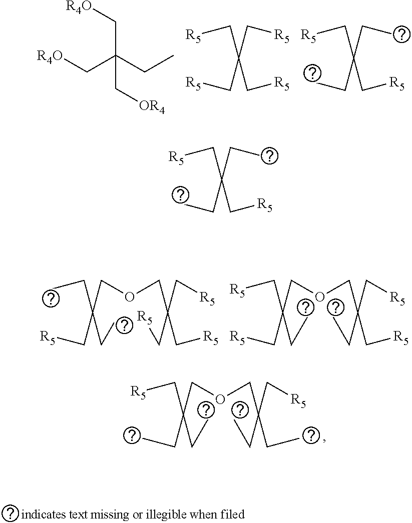

wherein R₄ and R₅ are independently selected from the group consisting of:

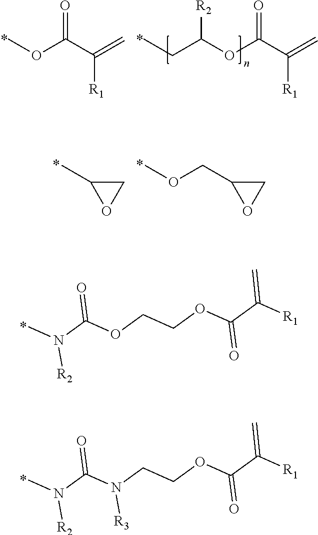

wherein R₁, R₂, R₃, and R₆ are each independently selected from the group consisting of hydrogen, methyl, ethyl, phenyl, methyl phenyl, benzyl, acryl, epoxy ethyl, isocyanate, cyclic carbonate, lactone, lactam, and vinyl, wherein n is an integer between 0 and 50,000 and * indicates a point of attachment.

In one embodiment, the electrolyte exhibits an improved capacity retention due to a more heterogenous or disordered network in comparison to that synthesized from a linear crosslinker.

In one embodiment, the crosslinker with three or more polymerizable or crosslinkable terminals has a formula as follows:

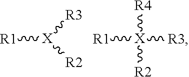

wherein X is C, Si, N, P, B, or a cyclic ring, wherein each independent R₁, R₂ and R₃ is a polymerizable or crosslinkable terminal connected to X directly or via a spacer chain or group.

In one embodiment, the three or more crosslinkable terminals include C₂₋₂₀ alkenyl, C₂₋₂₀ alkynyl, epoxy, amino, hydroxyl, carboxylic acid, or any substituted form thereof.

In one embodiment, the crosslinker with three or more polymerizable or crosslinkable terminals is a tri-acrylate, tetra-acrylate, modified tri-acrylate, modified tetra-acrylate, silane, siloxane or triazinane-trione.

In one embodiment, the crosslinked polymer is free of poly (ethylene oxide) chain.

In one embodiment, the crosslinker with three or more polymerizable or crosslinkable terminals is a silane or siloxane selected from the group consisting of:

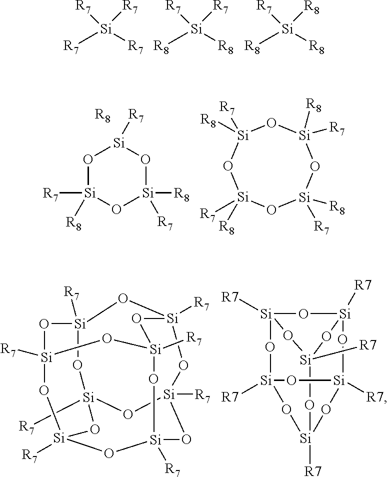

wherein R₇ is independently selected from the group consisting of:

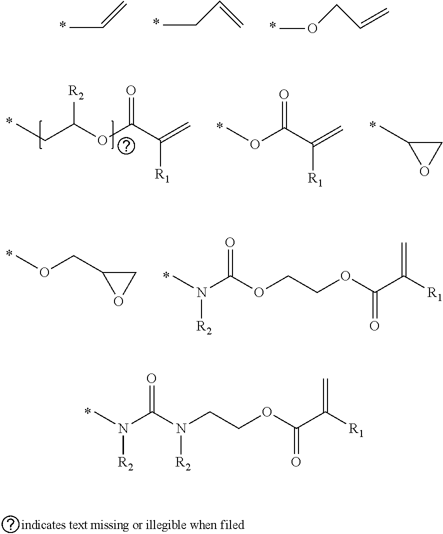

wherein R₁, R₂ and R₃ are each independently selected from the group consisting of hydrogen, methyl, ethyl, phenyl, methyl phenyl, benzyl, acryl, epoxy ethyl, isocyanate, cyclic carbonate, lactone, lactam, and vinyl, wherein q is an integer between 0 and 50,000, wherein R₈ is independently selected from the group consisting of:

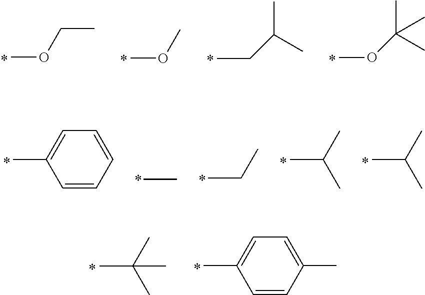

and * indicates a point of attachment.

In one embodiment, the crosslinker with three or more polymerizable or crosslinkable terminals has a formula:

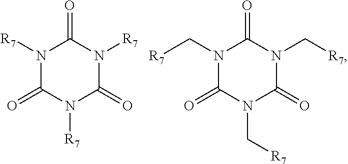

wherein R₇ is independently selected from the group consisting of:

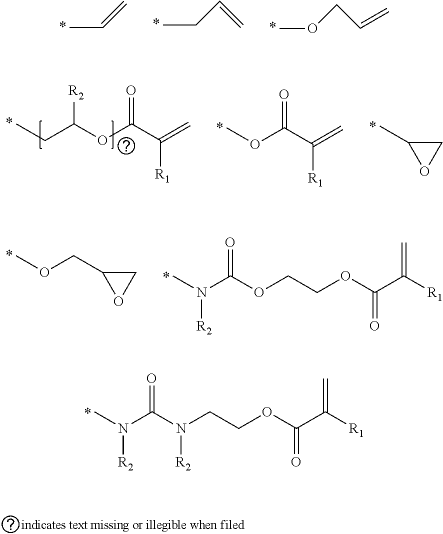

wherein R₁, R₂ and R₃ are each independently selected from the group consisting of hydrogen, methyl, ethyl, phenyl, methyl phenyl, benzyl, acryl, epoxy ethyl, isocyanate, cyclic carbonate, lactone, lactam, and vinyl, wherein q is an integer between 0 and 50,000 and * indicates a point of attachment.

In one embodiment, the electrolyte salt comprises a lithium salt selected from the group consisting of lithium perchlorate (LiClO₄), lithium hexafluorophosphate (LiPF₆), lithiumborofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate(LiNO₃), Li-fluoroalkyl-phosphates (LiPF₃(CF₂CF₃)₃), lithium bisperfluoro-ethysulfo-nylimide (LiBETI), lithium bis(trifluoromethanesulphonyl) imide, lithium bis(fuorosulphonyl)imide, lithium trifluoromethanesulfonimide (LiTFSI), lithium bis(fluorosulfonyl)imide (LiFSI), lithium difluoro(oxalato)borate (LiDFOB), lithium perchlorate (LiClO₄), LiC(CF₃SO₂)₃, LiF, LiCl, LiBr, LiI, Li₂SO₄, LiNO₃, Li₃PO₄, Li₂CO₃, LiOH, lithium acetate, lithium trifluoromethyl acetate and lithium oxalate.

In one embodiment, the one or more crosslinkers are crosslinked in the presence of an initiator, under UV light, or at an elevated temperature.

In one embodiment, the present invention discloses an electrochemical device comprising the electrolyte as described herein.

In one embodiment, the electrochemical device passes a short circuit test with an external resistance of 20 mΩ without causing any ruptures.

In one embodiment, the electrochemical device passes a short circuit test with an external resistance of 5 mΩ without causing any ruptures.

In one embodiment, the electrochemical device is anode-free or comprises an anode.

In one embodiment, the anode is a carbon anode, Li anode, Si anode, Alloy anode, Li₄Ti₅O₁₂, or made from conversion anode materials, wherein the carbon anode comprises graphite, soft carbon, hard carbon, or combinations of thereof, the Li anode comprises Li metal foil, Li metal on Cu, Ni, or stainless steel, the Si anode comprises Si, Si/Carbon composite, SiOₓ (0≤x<2), SiOₓ (0≤x<2)/carbon composite or a combination thereof, the Alloy anode comprises Sn, SnO₂, Sb, Al, Mg, Bi, In, As, Zn, Ga, B, or a combination thereof, and the conversion anode materials comprise MₐX_{b}, M is Mn, Fe, Co, Ni, or Cu, X is O, S, Se, F, N, or P, a and b are respectively 1 to 4.

In one embodiment, the electrochemical device comprises a cathode comprising an electroactive material including lithium nickel cobalt manganese oxide, lithium nickel cobalt aluminum oxide, lithium titanate, metallic lithium, lithium metal oxide, lithium manganese oxide, lithium cobalt oxide, and lithium iron phosphate.

As will be discussed below, Examples 1, 8-4, 8-8, and 8-9 are single crosslinker systems, and their respective ionic conductivities show that both PETA and UDMA have improved ionic conductivities in comparison to DA700. The improved ionic conductivity is likely due to the tetraacrylate functionality, enabling crosslinking from all four terminals while DA700 enables crosslinking from a linear crosslinker with two terminals. As a result, less crosslinker of PETA is used in the formulation, enabling faster lithium ions transport than that in DA700 formulations. For Examples 8-8 and 8-9, the electron-donating group, i.e., amide, in UDMA can facilitate lithium-ion transport.

Examples 8-5, 8-6, and 8-7 are dual crosslinker systems, and they show slightly improved ionic conductivities compared to Example 8-4, which is a single crosslinker system. The second crosslinkers in Examples 8-5, 8-6, and 8-7 are allyl/vinyl terminated silanes, which can crosslink and potentially be used in silicon-anode battery systems as additives. The addition of a second crosslinker to the electrolyte system disrupted the PETA crosslinking network, leading to a more heterogenous or disordered crosslinking network, or a polymer network with more topological defects, which would likely facilitate ion transport, as ions can move more freely in the electrolyte. As the amount of the added crosslinkers are small, the disruption in ion transport property is also small, as observed.

In some embodiments, polymer solid electrolytes such as those described herein may provide relatively high decomposition voltages. Polymer solid electrolytes with relatively high decomposition voltages may be particularly useful, for example, in applications where higher voltages are required. In certain cases, the decomposition voltage of the polymer solid electrolyte may be at least 0.1 V, at least 0.2 V, at least 0.3 V, at least 0.4 V, at least 0.5 V, at least 0.6 V, at least 0.7 V, at least 0.8 V, at least 0.9 V, at least 1 V, at least 1.5 V, at least 2 V, at least 2.5 V, at least 3 V, at least 3.5 V, at least 3.8 V, at least 4 V, at least 4.3 V, at least 4.5 V, at least 4.8 V, at least 5V, at least 5.3V, at least 5.5 V, or at least 6 V. Decomposition voltages can be tested using standard techniques known to those of ordinary skill in the art, such as cyclic voltammetry. Without wishing to be bound by any theory, the crosslinker without poly (ethylene oxide) chain is not easily oxidized A polymer solid electrolyte from such crosslinker can resist decomposition and possess a relatively higher decomposition voltage.

In some embodiments, the polymer solid electrolyte may include an additive for improving processability, and/or controlling the ionic conductivity and mechanical strength. For example, the additive may be a polymer, a small molecule (i.e., having a molecular weight of less than 1 kDa), a nitrile, an oligoether, cyclic carbonate, ionic liquids, or the like. Examples of the oligoether includes diethyl ether, 2-ethoxyethanol, dimethoxy methane, dimethoxy ethane, 1,2-diethoxyethane, 1,1-diethoxyethane, 1,1-dipropoxy-ethane, 1,2-dipropoxy-ethane, diethylene glycol, 2-(2-ethoxyethoxy)ethanol, diethylene glycol dimethyl ether, diethylene glycol diethyl ether, diethylene glycol dibutyl ether, triethylene glycol, tri(ethylene glycol) monomethyl ether, tri(ethylene glycol) monoethyl ether, tri(ethylene glycol) monobutyl ether, triethylene glycol dimethyl ether, triethylene glycol diethyl ether, diethylene glycol dibutyl ether, tetraethylene glycol, tetra(ethylene glycol) monomethyl ether, tetra(ethylene glycol) monoethyl ether, tetra(ethylene glycol) monobutyl ether, tetraethylene glycol dimethyl ether, tetraethylene glycol diethyl ether, tetraethylene glycol dibutyl ether, or the like. Non-limiting examples of potentially suitable additives include ethylene carbonate, diethyle carbonate, dimethyl carbonate, ethyl methyl carbonate, propylene carbonate, fluoroethylene carbonate, vinylene carbonate, succinonitrile, succinonitrile, glutaronitrile, hexonitrile, malononitrile, dimethyl sulfoxide, prop-1-ene-1,3-sultone, sulfolane, ethyl vinyl sulfone, tetramethylene sulfone, vinyl sulfone, methyl vinyl sulfone, phenyl vinyl sulfone, N-propyl-N-methylpyrrolidinium bis(fluorosulfonyl)imide, 1-ethyl-3-methylimidazolium bis(fluorosulfonyl)imide, trimethyl phosphate, triethyl phosphate, poly(ethylene oxide), or the like. In some case, the additives may act as solvent. In some other case, the additives may act as plasticizer.

In some embodiments, the additive can be present at a weight percentage of at least 1 wt %, at least 2 wt %, at least 3 wt %, at least 4 wt %, at least 5 wt %, at least 6 wt %, at least 7 wt %, at least 8 wt %, at least 9 wt %, at least 10 wt %, at least 11 wt %, at least 12 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, or at least 85wt %, based on a total weight of the electrolyte.

The electrolyte salt may include a lithium salt. Specific non-limiting examples of lithium salts include lithium perchlorate (LiClO₄), lithium hexafluorophosphate (LiPF₆), lithiumborofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate(LiNO₃), Li-fluoroalkyl-phosphates (LiPF₃(CF₂CF₃)₃), lithium bisperfluoro-ethysulfo-nylimide (LiBETI), lithium bis(trifluoromethanesulphonyl) imide, lithium bis(fuorosulphonyl)imide, lithium trifluoromethanesulfonimide (LiTFSI), lithium bis(fluo-rosulfonyl)imide (LiFSI), lithium difluoro(oxalato)borate (LiDFOB), LiC(CF₃SO₂)₃, LiF, LiCl, LiBr, LiI, Li₂SO₄, LiNO₃, Li₃PO₄, Li₂CO₃, LiOH, lithium acetate, lithium trifluoromethyl acetate, lithium oxalate, and a combination thereof.

In some embodiments, the electrolyte salt has a mole fraction of at least 0.5 M, at least 1M, at least 1.5M, at least 2M, at least 2.5M, at least 3M, at least 3.5M, at least 4M, at least 4.5M, at least 5M, at least 5.5 M, at least 6M, at least 6.5 M, at least 7 M, at least 7.5 M, at least 8 M, at least 8.5 M, at least 9 M, at least 9.5 M, at least 10 M and/or no more than 0.5M, no more than 1M, no more than 1.5M, no more than 2M, no more than 2.5M, no more than 3M, no more than 3.5M, no more than 4M, no more than 4.5M, no more than 5M, no more than 5.5 M, no more than 6M, no more than 6.5 M, no more than 7 M, no more than 7.5 M, no more than 8 M, no more than 8.5 M, no more than 9 M, no more than 9.5 M, no more than 10 M.

In some embodiments, an initiato r may be present. Specific non-limiting examples of initiators include Irgacure initiator, 2,2′-azobis(2-methylpropionitrile), benzoyl peroxide, cumene hydroperoxide, dicumyl peroxide, ter-butyl hydroperoxide, di-tert-butyl peroxide, 2,2′-azobis [2-(2-imidazoline-2-yl) propane] dihydrochloride, ammonium persulfate, anisoin, anthraquinone, benzophenone, benzoin methyl ether, 2-isopropylthioxanthone, 9,10-phenanthrenequinone, 3′-hydroxyacetophenone, 3,3′,4,4′-benzophenonetetreacarboxylic dianhydride, 2-benzoylbenzoic acid, (±)-camphorquinone, 2-ethylanthraquinone, 2-methylbenzophenone, 4-hydroxybenzophenone, 2-hydroxy-2-methylpropiophenone, benzoin isobutyl ether, 4,4′-bis(dimethylamino)benzophenone, 4,4′-dihydroxybenzophenone, 4-benzoyl 4′-methyldiphenyl sulfide, ferrocene, dibenzosuberenone, benzoin ethyl ether, benzil, methyl benzoylformate, 4-benzoylbenzoic acid, or others alike. In some cases, the initiator has a weight fraction (weight percentage) between 0.01 wt % and 5 wt %, or other suitable mole fractions to initiate crosslinking, based on a total weight of the polymer solid electrolyte. The present invention discovered that the weight fraction of initiator is preferably no more than a certain threshold value to avoid over-crosslinking and/or retain the heterogeneity of the polymer network. In one embodiment, the weight fraction is no more than 5.0 wt %, no more than 4.0 wt %, no more than 3.0 wt %, no more than 2.0 wt %, or no more than 1.0 wt %. In one embodiment, the weight fraction is no more than 1.0%, no more than 0.8 wt %, no more than 0.6 wt %, no more than 0.4 wt %, no more than 0.2 wt %, no more than 0.1 wt %, or no more than 0.05 wt %.

In certain cases, a polymer, an additive, and an electrolyte salt may each present within the electrolyte material at any suitable concentration. In addition, one or more than one of these may be present, e.g., there may be more than one polymer, and/or more than one plasticizer, and/or more than one electrolyte salt.

In one set of embodiments, the crosslinker(s) may be present at a weight percentage of at least 0.01 wt %, at least 0.02 wt %, at least 0.027 wt %, at least 0.03 wt %, at least 0.05 wt %, at least wt %, at least 0.11 wt %, at least 0.12 wt %, at least 0.13 wt %, at least 0.15 wt %, at least 0.2 wt %, at least 0.3 wt %, at least 0.5 wt %, at least 1.0 wt %, at least 1.5 wt %, at least 2.0 wt %, at least 2.5 wt %, at least 3 wt %, at least 3.5 wt %, at least 4 wt %, at least 4.5 wt %, at least 5.0 wt %, at least 6.0 wt %, at least 7.0 wt %, at least 8.0 wt %, at least 9.0 wt %, at least 10 wt %, at least 11 wt %, at least 12 wt %, at least 13 wt %, at least 14 wt %, at least 15 wt %, at least 30 wt %, at least 40 wt %, at least 50 wt %, and/or no more than 0.01 wt %, no more than 0.02 wt %, no more than 0.027 wt %, no more than 0.03 wt %, no more than 0.05 wt %, no more than 0.1 wt %, no more than 0.11 wt %, no more than 0.12 wt %, no more than 0.13 wt %, no more than 0.15 wt %, no more than 0.2 wt %, no more than 0.3 wt %, no more than 0.5 wt %, no more than 1.0 wt %, no more than 1.5 wt %, no more than 2.0 wt %, no more than 2.5 wt %, no more than 3 wt %, no more than 3.5 wt %, no more than 4 wt %, no more than 4.5 wt %, no more than 5.0 wt %, no more than 6.0 wt %, no more than 8.0 wt %, no more than 9.0 wt %, no more than 10 wt %, no more than 12 wt %, no more than 15 wt %, no more than 20 wt %, no more than 30 wt %, no more than 40 wt %, no more than 50 wt %, based on a total weight of the electrolyte.

In certain embodiments, the weight ratio of the crosslinker(s) based on total weight of electrolyte is no more than 30 wt %, no more than 20 wt %, no more than 10 wt %, no more than 8%, no more than 6%, no more than 5%, no more than 4%, or no more than 3% to prevent from over-crosslinking. Without wishing to be bound by any theory, an electrolyte comprising over-crosslinked polymer exhibits poor processability and ionic conductivity probably due to the rigid polymer network and restricted ion transport therein. The present invention also discovered that a film of polymer solid electrolyte became more rigid when the weight ratio of crosslinker(s) exceeded a certain threshold weight percentage or ratio which may be probably due to the over-crosslinking structure. In return, such over-crosslinking and rigid structure significantly deteriorated the electrochemical performance, especially cycling performance. In certain embodiments, the threshold weight ratio of the crosslinker(s) related to over-crosslinking may depend on molecular weight, number of crosslinkable terminals, density of electrolyte, etc. and subject to further adjustment as necessary.

In certain embodiments, the weight ratio of the crosslinker with at least three terminals based on total weight of electrolyte is no more than 20 wt %, no more than 10 wt %, no more than 8%, no more than 6%, no more than 5%, no more than 4%, no more than 3%, no more than 2% or no more than 1.5%. In certain embodiments, the threshold weight ratio of the crosslinker with at least three terminals related to over-crosslinking may depend on its molecular weight, number of crosslinkable terminals, density of electrolyte, etc. and subject to further adjustment as necessary.

In certain embodiments, the weight ratio of the crosslinker(s) based on total weight of electrolyte may be no less than 2%, no less than 1%, no less than 0.8%, no less than 0.5%, or no less than 0.1%. Without wishing to be bound by any theory, the minimum amount of crosslinker(s) is to keep the electrolyte in a solid rather than liquid form to ensure the processibility and stability.

As for crosslinked polymers synthesized from two crosslinkers, the weight ratio of these two crosslinkers ranges from 10:1 to 1:1 according to some embodiments of the present invention. In some embodiments, the molar ratio of two crosslinkers ranges from 10:1 to 1:1.

In certain embodiments, the weight ratio of the crosslinkers to the electrolyte salt is from about 50:1 to about 10:1. In certain embodiments, the weight ratio of the crosslinkers to the electrolyte salt is from about 10:1 to about 1:1.

In certain embodiments, the crosslinker or crosslinkers have a molecular weight of about 2 kDa or less, about 1.9 kDa or less, about 1.8 kDa or less, about 1.7 kDa or less, about 1.6 kDa or less, about 1.5 kDa or less, about 1.4 kDa or less, about 1.3 kDa or less, about 1.2 kDa or less, about 1.1 kDa or less, about 1.0 kDa or less, about 0.9 kDa or less, about 0.8 kDa or less, about 0.7 kDa or less, or about 0.6 kDa or less.

Combinations of any of one or more of the above ranges and intervals are also possible. For example, a crosslinker (including more than one crosslinker) has a weight fraction between 1 wt % and 50 wt % (that is, the total crosslinker does not exceed 50 wt %), an electrolyte salt (including more than one electrolyte salt) has a mole fraction between 1.0M and 4M. Without wishing to be bound by any theory, if the crosslinker concentration is too low, the solid electrolyte may be relatively soft, which could be hard to handle; however, if the crosslinker concentration is too high, the solid electrolyte may be very tough, easy to break during handling, and may not provide good adhesion.

Certain aspects of the present invention are generally directed to systems and methods for producing any of the polymer solid electrolytes discussed herein. For example, in one set of embodiments, a polymer may be produced by reacting various crosslinkers together.

In one set of embodiments, the crosslinker may be mixed with a solvent and electrolyte salts to form a slurry, which can be cured to form a solid electrolyte. In addition, in some cases, multiple crosslinkers may be present in the slurry, which may be added to the slurry sequentially, simultaneously, etc. The crosslinkers may each independently be crosslinkers as described herein, and/or other suitable crosslinkers.

In some embodiments, the slurry may be cured to form a film, such as a solid-state film. In some embodiments, the film has a thickness of between 100 nm and 500 μm. For instance, the mixture can be formed into a film by curing, for example, using UV light, thermoforming, exposure to elevated temperatures, or the like. For example, curing may be induced using exposure to UV light for at least 3 min, at least 5 min, at least 10 min, at least 15 min, etc., and/or by exposure to temperatures of at least 20° C., at least 30° C., at least 40° C., at least 50° C. , at least 60° C., at least 70° C., at least 80° C., at least 90° C., at least 100° C., at least 110° C., at least 120° C., at least 130° C., at least 140° C., at least 150° C., etc. As an example, a slurry may be coated or positioned on a surface and/or within a mold and exposed to UV light to cure.

In some cases, during the curing process, at least some of the crosslinkers may also crosslink, e.g., as discussed herein, which in some cases may improve various electrochemical performance. For example, exposure to UV light may facilitate the crosslinking process.

The present disclosure generally relates to a device with various polymer solid electrolyte materials mentioned above. The device may be a battery, an LIB or a lithium-ion solid-state battery. The battery may be configured for applications such as, portable applications, transportation applications, stationary energy storage applications, and the like. Non-limiting examples of the ion-conducing batteries include lithium-ion conducting batteries, and the like. The device may also be a battery comprising one or more lithium ions electrochemical cells.

In various examples, a battery includes an electrolyte of the present disclosure, an anode, and a cathode with an electroactive material.

In various examples, the anode includes carbon anode, Li anode, Si anode, Alloy anode, and/or conversion anode materials. The carbon anode includes graphite, soft carbon, hard carbon, or combinations of thereof. The Li anode includes Li metal foil, Li metal on Cu (or on other current collectors, such as stainless steel, Ni). The Si anode includes Si, Si/Carbon composite anode, SiOₓ (0≤x<2), SiOₓ((0≤x<2)/carbon composite anode. The Alloy anode includes Sn, SnO₂, Sb, Al, Mg, Bi, In, As, Zn, Ga, B. In various examples, a battery is anode free (only includes current collector)

The conversion anode materials include MₐX_{b}, M is Mn, Fe, Co, Ni, Cu, and X is O, S, Se, F, N, P, etc. In addition, a and b are respectively 1 to 4.

In various examples, other possible anode materials include Li₄Ti₅O₁₂.

In various examples, the electroactive material includes lithium nickel cobalt manganese oxide, lithium nickel cobalt aluminum oxide, lithium titanate, metallic lithium, lithium metal oxide, lithium manganese oxide, lithium cobalt oxide, and lithium iron phosphate.

In addition, in some embodiments, the electrochemical device has a capacity retention of to 100% after 87 cycles using a discharging current at a rate of 0.5 C at 25° C. or has a capacity retention of at least 99.2% after 73 cycles using a discharging current at a rate of 0.5 C at 25° C.

In addition, in some embodiments, the electrochemical device has a capacity retention of at least 41%, at least 46%, at least 51%, at least 56%, at least 62%, at least 67%, at least 72%, at least 77%, at least 82%, at least 87%, at least 90.7%, at least 92%, at least 95%, at least 97%, at least 99.2%, at least 99.3%, at least 99.5% or the like when a discharging current rate of 0.5 C being used at 25° C.

In addition, in some embodiments, the electrochemical device has an exothermic reaction of at least 130° C., at least 140° C., at least 150° C., at least 160° C., at least 170° C., at least 180° C., at least 190° C., at least 200° C., at least 210° C., at least 220° C., at least 230° C., at least 240° C., or at least 250° C.

In addition, the present disclosure generally relates to a method of making an article (such as the polymer solid electrolyte as disclosed herein). The method includes a step of mixing one or more crosslinkers to form a slurry and a step of curing the slurry by UV curing or by thermal curing to form a solid electrolyte, wherein at least one crosslinker has three or more polymerizable or crosslinkable terminals.

In addition, in some embodiments, the method further comprising adding the slurry to a mold prior to curing the slurry, coating the slurry on a surface prior to curing the slurry. In some embodiments, only one crosslinker is added. In some embodiments, multiple crosslinkers are added simultaneously or sequentially. In some alternative embodiments, additional crosslinkers (such as a second and/or third crosslinkers) may be subsequently added to the slurry prior to curing the slurry. In some embodiments, the subsequently added crosslinker may same as or different from the first added crosslinker. When multiple crosslinkers are used, the 2^{nd} crosslinker can be a monomer that can lead to a linear polymer, a branched polymer, or a crosslinked polymer.

In some embodiments, the slurry can be cured under UV light, or at an elevated temperature between 50° C. and 90° C. In some embodiments, the slurry comprises an initiator including without limitation Irgacure initiator, AIBN, and any other initiator mentioned above. In some embodiments, the slurry comprises an additive such as plasticizer as disclosed herein. In some embodiments, the slurry comprises an electrolyte salt.

In some embodiments, the method further includes transferring the slurry to a mold or coating the slurry on a surface prior to curing the slurry.

Some crosslinkers, electrolyte salts, additives and other materials as described in WO 2020096632 A1 and US application publication no. 20200144665 A1 and 20200144667 A1 are incorporated herein by reference in its entirety.

The following examples are intended to illustrate certain embodiments of the present invention, but do not exemplify the full scope of the invention.

Cycling performance: A coin cell battery with a cathode, an anode, a separator, and an electrolyte was discharged and charged between various voltage ranges at room temperature using a Neware tester with various current rates. Cycle life is determined by the number of cycles for the battery cell to reach 80% of its original capacity (capacity retention).

Electrochemical Impedance Spectroscopy (EIS) and ionic conductivity: EIS was performed by AC impedance analyzer (Interface 1010E Potentiostate, Gamry) on an ionic conductivity cell. The frequency from 1 MHz to 1 Hz was applied in testing. An ionic conductivity cell is comprised of a stainless steels coin cell bottom, a silicone ring washer of known thickness and ring width, a gasket/O-ring a spacer, a spring, and a coin cell top. The electrolyte is placed within the ring of the silicone ring washer and bulk resistance from the measurement represents that of the electrolyte.

NMC811: lithium nickel manganese cobalt oxide (LiNi_{0.8}Mn_{0.1}Co_{0.1}O₂ in Example below)

NCA: lithium nickel cobalt aluminium oxide (LiNi_{0.8}Co_{0.15}Al_{0.08}O₂ in Example below)

SiOₓ: silicon monoxide (0≤x<2, x=1 in the examples below)

### EXAMPLE 1

Solid-state polymer electrolytes were obtained by mixing a crosslinker 1 (2,2,3,3-tetrafluorobutane-1,4-diacrylate, 3 wt % for Example 1-1, 5 wt % for Example 1-2), 3.5M LiFSI, an additive, and 0.1 wt % AIBN as initiator by mechanical stirring at room temperature.

The polymer solid electrolyte was assembled in a 2032-coin cell with SiOx as anode, and NCM as cathode, and the as-assembled cell was thermally cured at 60° C. for 1 to 2 hours. The cycling test was performed with a Neware cycling tester. All the batteries were tested using the same charging and discharging rate. The charge/discharge voltage window was from 2.8 V to 4.2 V. The battery was cycled at a current rate of 0.1 C from the first cycle to the third cycle, then the battery was cycled at a current rate of 0.2 C from the fourth cycle to the sixth cycle, then the battery was cycled at a current rate of 0.33 C from the seventh cycle to the ninth cycle, then the battery cycle at a current rate of 0.5 C for full cell.

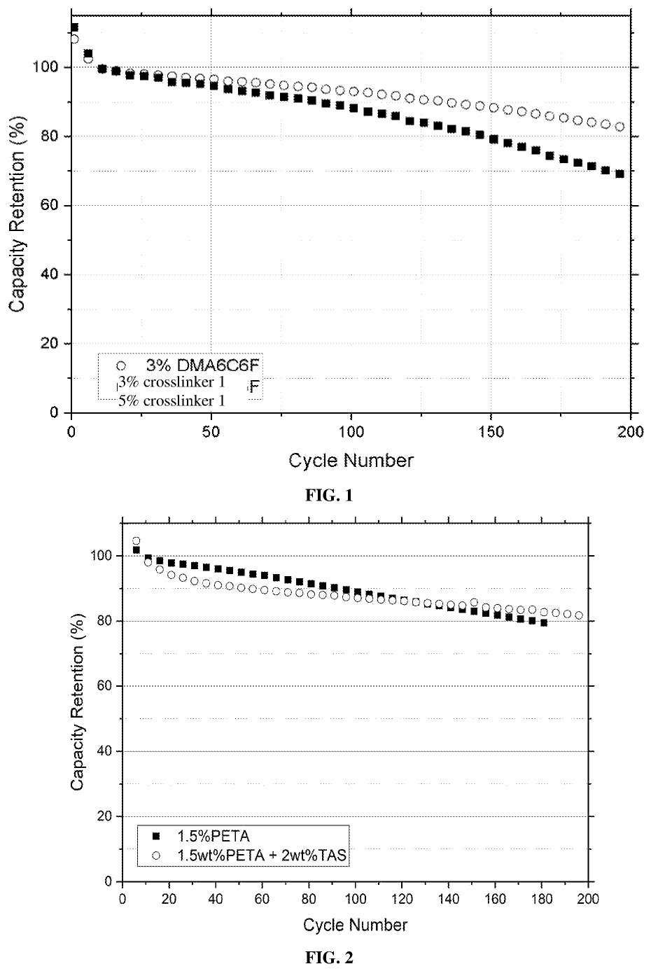

FIG. 1 shows the capacity retention of various amounts of crosslinker 1. At 200 cycles, Example 1-1 (with 3 wt % crosslinker 1) retains 82.5% of its original capacity, while Example 1-2 (with 5 wt % crosslinker 1) retains 68.3% of its original capacity. Example 1-2 has shown limited lithium-ion conduction in the polymer electrolyte. The result of this limitation in ion transport has led to a more rapid capacity fade as compared to Example 1-1 (with 3 wt % crosslinker 1). With optimal amount of crosslinker 1, the cell performance can sustain better capacity retention and longer cycle life.

### EXAMPLE 2

In Example 2, crosslinker 2a (2,2,3,3,4,4,5,5-octafluorohexane-1,6-diyl diacrylate) and crosslinker 2b (2,2,3,3,4,4,5,5-octafluorohexane-1,6-diyl bis(2-methylacrylate)) are respectively utilized.

Solid-state polymer electrolytes were obtained by mixing a single crosslinker (5 wt % of crosslinker 2a for Example 2-1, 10 wt % of crosslinker 2a for Example 2-2, 5 wt % of crosslinker 2b for Example 2-3, 10 wt % of crosslinker 2b for Example 2-4), 3.5M lithium salts (bis(fluorosulfonyl)imide, LiFSI), an additive, and 0.1 wt % AIBN as initiator by mechanical stirring at room temperature in the liquid state, and the as-assembled cell was thermally cured at 60° C. for 1 to 2 hours. Examples 2-1, 2-2, 2-3, and 2-4 were all well crosslinked.

### EXAMPLE 3

In Example 3, crosslinker 3 (tetraallyl silane, TAS), crosslinker 4 (diallyl dimethylsilane), crosslinker 5 (2,4,6,8-tetramethyl-2,4,6,8-tetravinylcyclotetrasiloxane), crosslinker 6 (allyltriethoxysilane), crosslinker 7 (poly(ethylene glycol) diacrylate (Mn 700)), and crosslinker 8 (pentaerythritol tetraacrylate) are utilized.

A solid-state polymer electrolyte was obtained by mixing two crosslinkers (2 wt % of crosslinker 3 and 5 wt % of crosslinker 7 for Example 3-1, 2 wt % of crosslinker 5 and 5 wt % of crosslinker 7 for Example 3-2,2 wt % of crosslinker 4 and 5 wt % of crosslinker 7 for Example 3-3,2 wt % of crosslinker 6 and 5 wt % of crosslinker 7 for Example 3-4,2 wt % of crosslinker 3 and 2 wt % of crosslinker 8 for Example 3-5,2 wt % of crosslinker 5 and 2 wt % of crosslinker 8 for Example 3-6), 3.5M LiFSI, an additive, and 0.1 wt % AIBN as initiator by mechanical stirring at room temperature in the liquid state, and the as-assembled cell was thermally cured at 60° C. for 1 to 2 hours. Examples 3-1, 3-2, 3-3, 3-4, 3-5, and 3-6 were all well crosslinked.

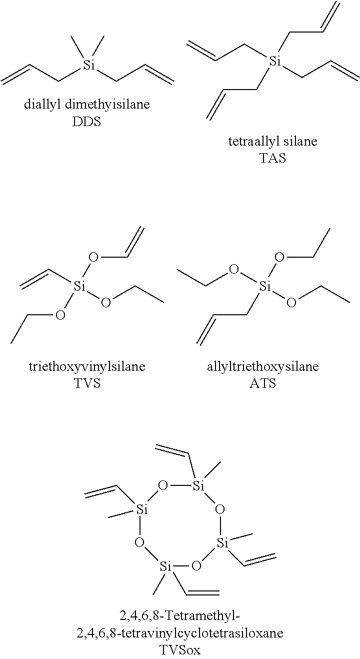

### EXAMPLE 4

### Example 4-1

A solid-state polymer electrolyte was obtained by mixing 1.5 wt % of crosslinker 8 (pentaerythritol tetraacrylate, PETA), 3.5M LiFSI as electrolyte salt, 0.1 wt % AIBN and an additive by mechanical stirring at room temperature in the liquid state.

### Example 4-2

A solid-state polymer electrolyte was obtained by mixing 1.5 wt % of crosslinker 8 (pentaerythritol tetraacrylate, PETA) and 2 wt % of crosslinker 9 (tetraallyl silane, TAS), 0.1 wt % AIBN as initiator, 3.5M LiFSI as electrolyte salt, and an additive by mechanical stirring at room temperature in the liquid state.

The liquid and viscous mixture above was applied onto a polyethylene terephthalate (PET) substrate to form a coating followed by curing at 60° C. for 1 to 2 hours.

The polymer solid electrolyte was assembled in a 2032-coin cell with SiOₓ as anode, and NCA815 as cathode, and the as-assembled cell was thermally cured at 60° C. for 1 to 2 hours. The cycling test was performed with a Neware cycling tester. All the batteries were tested using the same charging and discharging rate. The charge/discharge voltage window was from 2.8 V to 4.2 V. The battery was cycled at a current rate of 0.1 C from the first cycle to the third cycle, then the battery was cycled at a current rate of 0.2 C from the fourth cycle to the sixth cycle, then the battery was cycled at a current rate of 0.33 C from the seventh cycle to the ninth cycle, then the battery cycle at a current rate of 0.5 C for full cell.

FIG. 2 shows the capacity retention of the single crosslinker system (Example 4-1; PETA only) compared to dual crosslinker system (Example 4-2; PETA and TAS). The dual crosslinker system shows small improvement in capacity retention as compared to the single crosslinker system, retaining 82.9% after 180 cycles (comparing with 75.6% of the single crosslinker system). This improvement is likely due to the added crosslinker (crosslinker 9) disrupted the crosslinking network of the first crosslinker (crosslinker 8), making the polymer network more disordered. A disordered polymer network can better facilitate ion transport than an ordered polymer network. As only a small amount of second crosslinker (crosslinker 9) is added to the system, a small improvement is observed in the capacity retention of the resulting formulation.

### EXAMPLE 5

### Example 5-1

A solid-state polymer electrolyte was obtained by mixing 3 wt % of crosslinker (tris[2-(acryloyloxy)ethyl] isocyanurate, TAEI), 1 wt % AIBN as initiator, 3.5M LiFSI and an additive by mechanical stirring at room temperature in the liquid state.

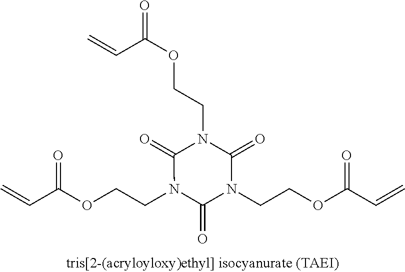 [SMILES: C=CC(=O)OCCn1c(=O)n(CCOC(=O)C=C)c(=O)n(CCOC(=O)C=C)c1=O]

### Example 5-2

A solid-state polymer electrolyte was obtained by mixing the 5 wt % of crosslinker (poly (ethylene glycol) diacrylate, Mn=700, DA700), 3.5M LiFSI, 0.1 wt % AIBN and an additive by mechanical stirring at room temperature in the liquid state.

The polymer solid electrolyte was assembled in a 2032-coin cell with Gr as anode, NCM811 as cathode, and NPore as separator, and the as-assembled cell was thermally cured at 60° C. for 1 to 2 hours. The cycling test was performed with a Neware cycling tester. All the batteries were tested using the same charging and discharging rate. The charge/discharge voltage window was from 2.8 V to 4.2 V. The battery was cycled at a current rate of 0.1 C from the first cycle to the third cycle, then the battery was cycled at a current rate of 0.2 C from the fourth cycle to the sixth cycle, then the battery was cycled at a current rate of 0.33 C from the seventh cycle to the ninth cycle, then the battery cycle at a current rate of 0.5 C for full cell.

The data for Example 5-2 was tested with 2.5 mAh/cm² NCM (less harsh condition) and the data for Example 5-1 was tested with 3.0 mAh/cm² NCM (harsher condition). Although the testing conditions were not identical, the difference confirms that the crosslinker in Example 5-1 shows better performance than the crosslinker in Example 5-2.

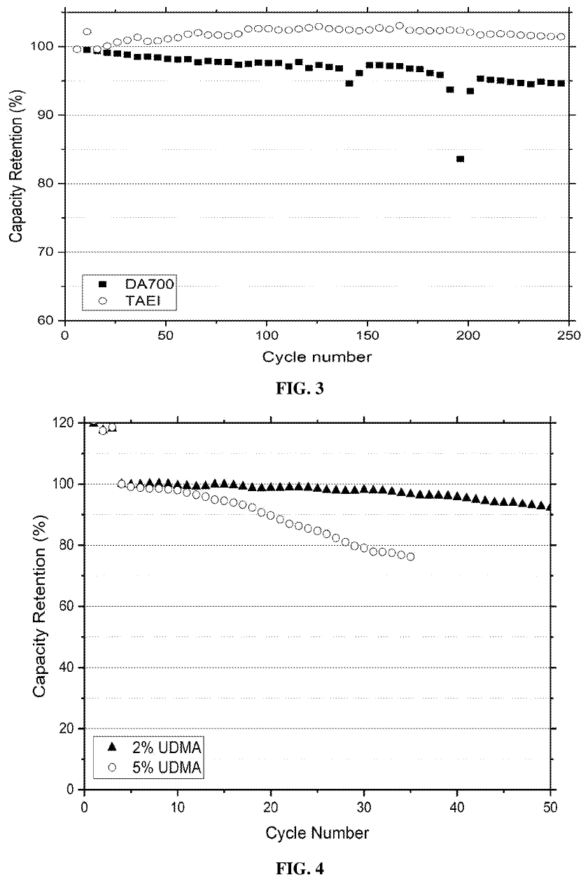

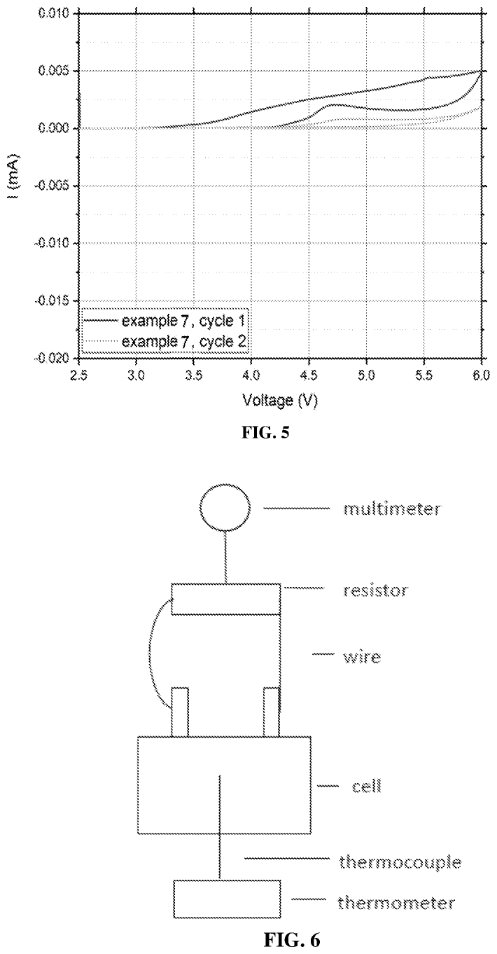

FIG. 3 shows the capacity retention of Examples 5-1 and 5-2. At 250 cycles, Example 5-2 retains 94.3% of its original capacity, while Example 5-1 still has a capacity retention above 100%. Even though the two experiments were conducted with slightly different electrode loadings (Example 5-2 at a lower loading and less harsh condition (2.5 mAh/cm² cathode loading and 2.8 anode loading) and Example 5-1 at higher loading and harsher condition (3.0 mAh/cm² cathode loading and 3.3 mAh/cm² anode loading)), the trend is consistent in showing that Example 5-1 shows superior stability than Example 5-2 by exhibiting superior capacity retention even under harsher conditions. The superior capacity retention of Example 5-1 is likely two folds. On the one hand, the crosslinker in Example 5-1 has three crosslinkable terminals as compared to two crosslinkable terminals in the crosslinker in Example 5-2. Therefore, the crosslinker in Example 5-1 can form polymer network more efficiently than the crosslinker in Example 5-2. On the other hand, the crosslinker in Example 5-1 contains imide functionality, which is stable at high voltages and also could facilitate ion transport in the polymer network. All these properties contribute to the superior cycling stability of Example 5-1.

### EXAMPLE 6

A solid-state polymer electrolyte was obtained by mixing a crosslinker (2 wt % UDMA for Example 6-1, 5 wt % UDMA for Example 6-2), 0.1 wt % AIBN as initiator, 3.5M LiFSI, and an additive by mechanical stirring at room temperature in the liquid state.

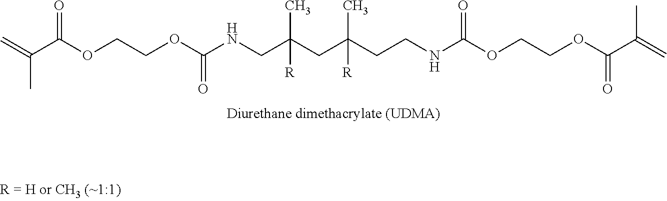

The polymer solid electrolyte was assembled in a 2032-coin cell with Li foil as anode, NCM as cathode, and modified Senior as separator, and the as-assembled cell was thermally cured at 60° C. for 1 to 2 hours. The cycling test was performed with a Neware cycling tester. The charge/discharge voltage window was from 2.8 V to 4.2 V. The battery was cycled at a current rate of 0.05 C for the first cycle, then the battery was cycled at a current rate of 0.2 C from the second cycle to the third cycle, then the battery was charged with continuous current (CC) at a current rate of 0.5 C and discharged with continuous current (CC) at a current rate of 1 C for the next 500 cycles.

FIG. 4 shows the capacity retention curves of different amount of crosslinker UDMA in the formulation. As shown in FIG. 4, Example 6-1 retained 92% capacity retention after 50 cycles while in Example 6-2, the capacity reached 80% at 28th cycle. It shows that Example 6-2 is likely to limit the lithium ions transport in the polymer electrolyte network due to containing more crosslinker than Example 6-1, which causes more rapid capacity fade. While at less crosslinker amount in Example 6-1, lithium ions movement is not limited by the density of the crosslinked polymer network because the kinetic limitation is lessened. In addition, the N—R/N—H in the crosslinker in this example can facilitate lithium ions transport better than PEO chains.

### EXAMPLE 7

A solid-state polymer electrolyte was obtained by mixing a crosslinker (1.5 wt % PETA), 4 M LiFSI, 0.1 wt % AIBN as initiator, and an additive by mechanical stirring at room temperature in the liquid state. The as-assembled cell was thermally cured at 60° C. for 1 to 2 hours.

The polymer solid electrolyte was assembled in a 2032-coin cell with Li foil as anode, and stainless steel spacer as cathode.

Cyclic voltammetry: a CR2032 coin cell (Stainless steel spacer for low voltage range or Al-clad for high voltage range) was used for CV cycling. A stainless steel spacer is used as the cathode and a lithium foil in the low voltage range, the Al-clad case was used directly as the cathode in the high voltage range. Electrolyte and separator were added between the cathode and the anode. Gamry 1010B potentiostat was used and the voltage range was defined as shown, scanning at 0.1 mV/s for 2 cycles.

FIG. 5 shows that electrochemical stability was tested between 2-6V, and no other significant electrochemical or redox processes observed except for the small passivation process at 4.7V in cycle 1, and only minimal current was observed in cycle 2, indicating the formation of a passivation layer on the electrode upon oxidation. The formation of such passivation layer is beneficial for the protection of electrodes and battery performance at high voltages. Within the voltage range examined, the polymer electrolyte formulation in FIG. 5 shows electrochemical stability up to 6V.

In some embodiment, the crosslinker with four terminals can be synthesized as follows:

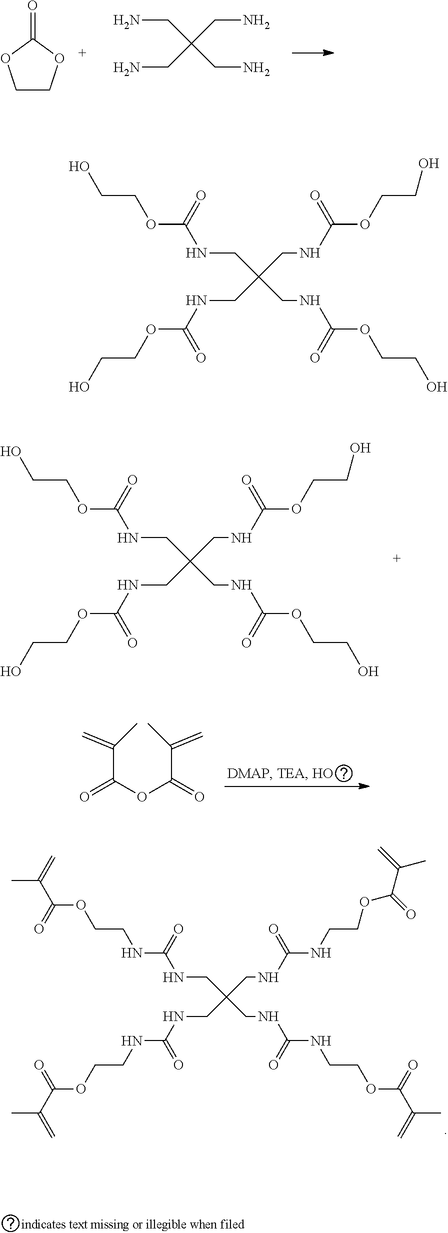 [SMILES: O=C1OCCO1 ; NCC(CN)(CN)CN ; O=C(NCC(CNC(=O)OCCO)(CNC(=O)OCCO)CNC(=O)OCCO)OCCO ; O=C(NCC(CNC(=O)OCCO)(CNC(=O)OCCO)CNC(=O)OCCO)OCCO ; C=C(C)C(=O)OC(=O)C(=C)C ; C=C(C)C(=O)OCCNC(=O)NCC(CNC(=O)NCCOC(=O)C(=C)C)(CNC(=O)NCCOC(=O)C(=C)C)CNC(=O)NCCOC(=O)C(=C)C]

In some embodiment, the crosslinker with four terminals can be synthesized as follows:

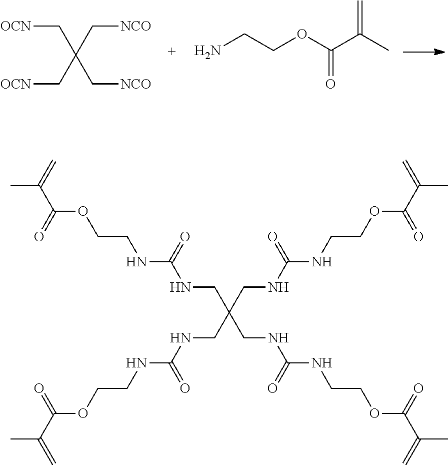

### EXAMPLE 8

A solid-state polymer electrolyte was obtained by mixing a single crosslinker or dual crosslinkers, 3.5M LiFSI, 0.1 wt % AIBN as initiator, and an additive with ratios described below by mechanical stirring at room temperature in the liquid state.

The above mixture was applied to an ionic conductivity cell described below. The as assembled cells were thermally curing at 60° C. for 1 to 2 hours. EIS and ionic conductivity of the membrane were determined on the cells, as follows.

In Example 8, crosslinker 3 (tetraallyl silane), crosslinker 10 (SiO₂ 380), crosslinker 11 (SiO₂ 711), crosslinker 12 (SiO₂ 7200), crosslinker 7 (poly(ethylene glycol) diacrylate (Mn 700)), crosslinker 8 (pentaerythritol tetraacrylate), crosslinker 5 (2,4,6,8-tetramethyl-2,4,6,8-tetravinylcyclotetrasiloxane), crosslinker 13 (diallyl dimethylsilane), and crosslinker 14 (diurethane dimethacrylate) are utilized. Fumed silica (SiO₂) are obtained from commercial source, Evoniks, under the tradename Aerosil.

TABLE 1
Examples with crosslinker(s) and their ionic conductivity

| | | Ionic |
|---|---|---|
| Example | | conductivity/ |
| No. | Crosslinker(s) | mS/cm |
| 8-1 | 4 wt % crosslinker 7 + 2 wt % crosslinker 10 | 0.91 |
| 8-2 | 4 wt % crosslinker 7 + 2 wt % crosslinker 11 | 0.97 |
| 8-3 | 4 wt % crosslinker 7 + 2 wt % crosslinker 12 | 1.00 |
| 8-4 | 1.5 wt % crosslinker 8 | 1.23 |
| 8-5 | 1.5 wt % crosslinker 8 + 2 wt % crosslinker 3 | 1.26 |
| 8-6 | 1.5 wt % crosslinker 8 + 2 wt % crosslinker 5 | 1.04 |
| 8-7 | 1.5 wt % crosslinker 8 + 2 wt % crosslinker 13 | 1.33 |
| 8-8 | 2 wt % crosslinker 14 | 1.52 |
| 8-9 | 3 wt % crosslinker 14 | 1.31 |

Examples 8-4, 8-8 and 8-9 are single crosslinker systems, and their respective ionic conductivities show that both crosslinker 8 and crosslinker 14 have improved ionic conductivities as compared to crosslinker 7. The improved ionic conductivity from crosslinker 8 is likely due to the tetraacrylate functionality, enabling it to crosslink from all four terminals rather than from two terminals of the linear crosslinker 7, thus leading to a less ordered polymer network. In addition, in comparison with crosslinker 7 in Examples 8-1, 8-2, and 8-3, crosslinker 8 with a relatively lower concentration is used in Examples 8-4, 8-5, 8-6 and 8-7, resulting in a relatively lower crosslinking density which enables faster lithium ions transport than that in crosslinker 7 formulations. Further, by comparing Examples 8-8 and 8-9 with other examples, crosslinker 14 has an electron-donating group, i.e., amide, and the corresponding electrolyte exhibits a much higher ionic conductivity because the electron-donating group facilitates and promotes lithium-ion transport.

Examples 8-5, 8-6 and 8-7 are dual crosslinker systems, and they show slightly improved ionic conductivities compared to Example 8-4, a single crosslinker system. The second crosslinkers added in Examples 8-5, 8-6 and 8-7 are allyl/vinyl terminated silanes, which can crosslink and potentially be used in silicon-anode battery systems as additives. Without wishing to be bound by any theory, the addition of a second crosslinker to the electrolyte system disrupted the crosslinker 8 crosslinking network, and a more disordered crosslinking network would likely improve ion transport, as ions can move more freely in the electrolyte. As the amount of the added crosslinkers are small, the disruption in ion transport property is also small, as observed.

### EXAMPLE 9

1 M LiPF₆ in ethylene carbonate and dimethyl carbonate (1:1 by volume) were mixed to serve as a base solution.

2 wt % triethylene glycol dimethacrylate (TEGDMA) (crosslinker with two functional groups), 2 wt % tris[2-(acryloyloxy)ethyl] isocyanurate (TAEI) (crosslinker with three functional groups) and 1 wt % AIBN were added to the base solution. After a stirring of 30 min, a homogeneous clear solution of LiPF₆, TEGDMA, TAEI, and AIBN is formed.

A 5 ml of the above solution was injected into a pouch cell.

After the solution is evenly distributed, e.g., standing still for 48 hours at room temperature, the cell was placed in an oven at 65° C. for 2 hours to polymerize or crosslink the crosslinkers into a crosslinked copolymer (alternatively, polymer composite), thereby forming a solid polymer electrolyte comprising the polymer composite.

### EXAMPLE 10

1 M LiPF₆ in ethylene carbonate and dimethyl carbonate (1:1 by volume) were mixed to serve as base solution.

2 wt % triethylene glycol dimethacrylate (TEGDMA) (crosslinker with two functional groups), 2 wt % di(trimethylolpropane) tetraacrylate (Di-TMPTA) (crosslinker with four functional groups) and 1 wt % AIBN were added to the base solution. After a stirring of 30 min, a homogeneous clear solution of LiPF₆, TEGDMA, Di-TMPTA, and AIBN is formed.

A 5 ml of the above solution was injected into a pouch cell.

After the solution is evenly distributed, e.g., standing still for 48 hours at room temperature, the cell was placed in an oven at 65° C. for 2 hours to polymerize or crosslink the crosslinkers into a crosslinked copolymer (alternatively, polymer composite), thereby forming a solid polymer electrolyte comprising the polymer composite.

### EXAMPLE 11

External short circuit tests consist of short circuiting a battery from outside to simulate incorrect battery use that may cause fire or rupture. A fully charged battery's positive and negative terminals are connected to an external resistor. The real time battery voltage and current are monitored by a multimeter. The temperature of cell body is monitored by a thermometer with K-type thermocouple.

### External Short Circuit Test #1

Ambient temperature is 17° C.; external resistance is 0.02 Ohms. The external resistance here is four times smaller than the standard requirement (0.1 Ohms for UN38.3, 0.08 Ohms for UL1642). As a result, the cell is under a more extreme abuse condition than the standard external short circuit test protocol.

The single polymer control cell showed a cell body temperature of over 300° C. during the test, and the cell ruptured due to thermal runaway. Because of the increased resistance, the polymer composite cell shows a 5% decrease in discharge capacity comparing to the control. The increases resistance significantly improved the safety performance the max current and max temperature are the lowest among all the groups.

TABLE 2

| | Discharge Capacity | Max | Cell max | |
|---|---|---|---|---|
| Group | (mAh/g) | current (A) | Temperature (° C.) | Results |
| Single polymer control * | 181.92 | 80 | >300 | rupture |
| Polymer composite | 170.39 | 60 | 110 | Pass |

* The electrolyte control comprising a single polymer was prepared by mixing 1.5 wt % PETA, 4M LiFSI, 0.1 wt % AIBN an initiator, and a plasticizer by mechanical stirring at room temperature in liquid state. The mixture was injected into a pouch cell and waited for 48 h. Then the pouch cell was left in the oven at 65° C. for 2 hours to enable thermal crosslinking.

### External Short Circuit Test #2

Ambient temperature is 18° C.; external resistance is 0.005 Ohms. The external resistance here is sixteen times smaller than the standard requirement (0.1 Ohms for UN38.3, 0.08 Ohms for UL1642). As a result, the cell is under a more extreme abuse condition than the standard external short circuit test protocol.

At 0.005 Ohms external resistance, the single polymer control cell showed a 120 A max current, 50% higher than at 0.02 Ohms condition. Unsurprisingly, the cell also ruptured due to thermal runaway. The polymer composite cell again demonstrated outstanding safety feature: max current and max temperature 64% and 33% of the control cell, respectively.

TABLE 3

| | Discharge capacity | | Cell max | |
|---|---|---|---|---|
| Group | (mAh/g) | Max current (A) | Temperature (° C.) | Results |
| Single polymer control * | 177.99 | 120 | >300 | rupture |
| Polymer composite | 171.68 | 77 | 103 | Pass |

* Same as the one in test #1.

### EXAMPLE SUMMARY

In summary, the incorporation of a polymer network with at least three crosslinkable terminals into electrolyte considerably improves various electrochemical performances and safety. These polymer solid electrolytes may achieve safe, long life lithium secondary batteries. In addition, the lack of poly(ethylene oxide) groups in the polymer chains can lead to a more stable material with higher decomposition potential. These properties may benefit the charging/discharging rate performances of LIBs. The improved decomposition potential can also provide enhanced stability, which may provide longer life and/or higher voltage lithium batteries. In certain embodiments, the polymer solid electrolytes in some examples did not use any organic solvents. Thus, they may reliably provide safe performance of lithium ions batteries, as well as other applications.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the invention includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

1-26. (canceled)

27. A polymer solid electrolyte comprising:
a) an electrolyte salt, and
b) a crosslinked polymer with a heterogenous or disordered polymer network obtained from a crosslinking reaction of a composition comprising one or more crosslinkers, wherein at least one crosslinker has three or more polymerizable or crosslinkable terminals and the crosslinker has a formula selected from the group consisting of: 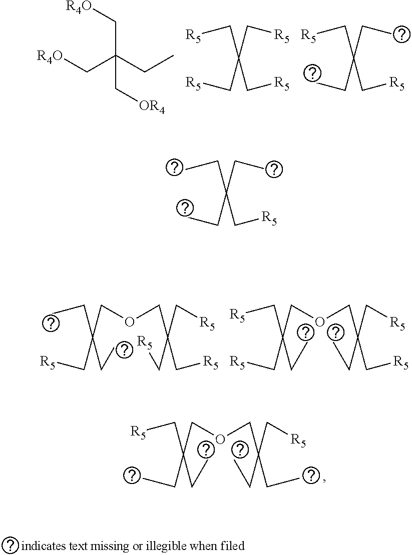
wherein R₄ and R₅ are independently selected from the group consisting of: 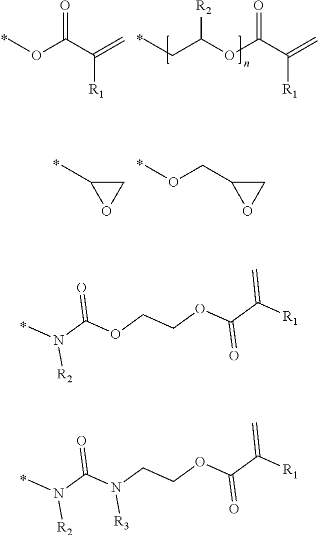
wherein R₁, R₂, R₃, and R₆ are each independently selected from the group consisting of hydrogen, methyl, ethyl, phenyl, methyl phenyl, benzyl, acryl, epoxy ethyl, isocyanate, cyclic carbonate, lactone, lactam, and vinyl, wherein n is an integer between 0 and 50,000 and * indicates a point of attachment.

28. The electrolyte of claim 27, wherein the crosslinked polymer is not over-crosslinked.

29. The electrolyte of claim 28 wherein the crosslinked polymer is obtained from:
a. a composition comprising the one or more crosslinkers with a concentration of no less than 0.1 wt % and no more than 30 wt %; or
b. a composition comprising the crosslinker with three or more polymerizable or crosslinkable terminals at a concentration of no less than and no more than 20 wt %.

30. The electrolyte of claim 27, wherein at least one of the one or more crosslinkers has an electron-donating group, which promotes ion transport in the electrolyte.

31. The electrolyte of claim 30, wherein the electron-donating group is an amide.

32. The electrolyte of claim 27, wherein the crosslinked polymer is free of poly (ethylene oxide) chain.

33. The electrolyte of claim 27, wherein the electrolyte exhibits an improved capacity retention due to a more heterogenous or disordered network in comparison to that synthesized from a linear crosslinker.

34. The electrolyte of claim 27, wherein the electrolyte salt comprises a lithium salt selected from the group consisting of lithium perchlorate (LiClO₄), lithium hexafluorophosphate (LiPF₆), lithiumborofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate(LiNO₃), Li-fluoroalkyl-phosphates (LiPF₃(CF₂CF₃)₃), lithium bisperfluoro-ethysulfonylimide (LiBETI), lithium bis (trifluoromethanesulphonyl) imide, lithium bis(fuorosulphonyl)imide, lithium trifluoromethanesulfonimide (LiTFSI), lithium bis(fluorosulfonyl)imide (LiFSI), lithium difluoro(oxalato)borate (LiDFOB), LiC(CF₃SO₂)₃, LiF, LiCl, LiBr, LiI, Li₂SO₄, Li₃PO₄, Li₂CO₃, LiOH, lithium acetate, lithium trifluoromethyl acetate and lithium oxalate.

35. The electrolyte of claim 27, wherein the one or more crosslinkers are crosslinked in the presence of an initiator, under UV light, or at an elevated temperature.

36. An electrochemical device, comprising the electrolyte of claim 27.

37. The electrochemical device of claim 36, wherein the electrochemical device passes a short circuit test with an external resistance of 20 mΩ without causing any ruptures.

38. The electrochemical device of claim 36, wherein the electrochemical device passes a short circuit test with an external resistance of 5 mΩ without causing any ruptures.

39. The electrochemical device of claim 36, wherein the electrochemical device is anode-free or comprises an anode.

40. The electrochemical device of claim 38, wherein the anode is a carbon anode, Li anode, Si anode, alloy anode, Li₄Ti₅O₁₂, or made from conversion anode materials, wherein the carbon anode comprises graphite, soft carbon, hard carbon, or combinations of thereof.

41. The electrochemical device of claim 40, wherein the Li anode comprises Li metal foil, Li metal on Cu, Ni, or stainless steel.

42. The electrochemical device of claim 40, wherein the Si anode comprises Si, Si/Carbon composite, SiOₓ (0≤x<2), SiOₓ (0≤x<2)/carbon composite or a combination thereof, the Alloy anode comprises Sn, SnO₂, Sb, Al, Mg, Bi, In, As, Zn, Ga, B, or a combination thereof.

43. The electrochemical device of claim 40, wherein the conversion anode materials comprise MₐX_{b}, M is Mn, Fe, Co, Ni, or Cu, X is O, S, Se, F, N, or P, a and b are respectively 1 to 4.

44. The electrochemical device of claim 36, wherein the electrochemical device comprises a cathode.

45. The electrochemical device of claim 44, wherein the cathode comprises an electroactive material selected from the group consisting of lithium nickel cobalt manganese oxide, lithium nickel cobalt aluminum oxide, lithium titanate, metallic lithium, lithium metal oxide, lithium manganese oxide, lithium cobalt oxide, and lithium iron phosphate.

46. A polymer solid electrolyte comprising:
a) an electrolyte salt, and
b) a crosslinked polymer with topological defects synthesized from one or more crosslinkers, wherein at least one crosslinker has three or more polymerizable or crosslinkable terminals, wherein at least one crosslinker has three or more polymerizable or crosslinkable terminals and the crosslinker has a formula selected from the group consisting of: 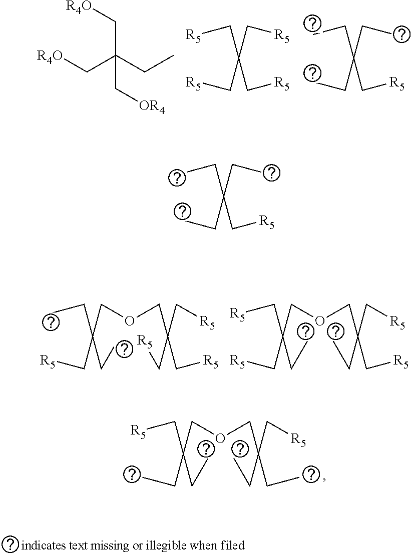
wherein R₄ and R₅ are independently selected from the group consisting of: 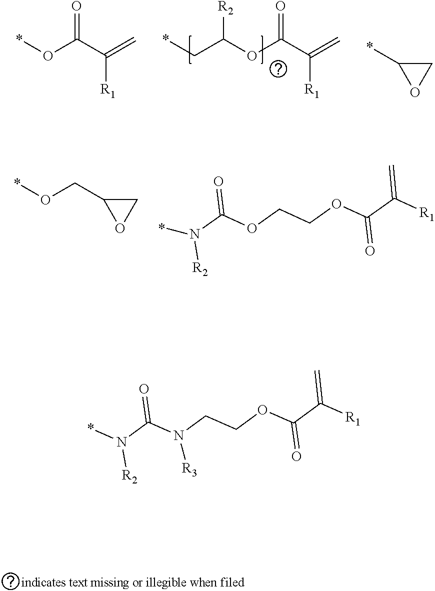
wherein R₁, R₂, R₃, and R₆ are each independently selected from the group consisting of hydrogen, methyl, ethyl, phenyl, methyl phenyl, benzyl, acryl, epoxy ethyl, isocyanate, cyclic carbonate, lactone, lactam, and vinyl, wherein n is an integer between 0 and 50,000 and * indicates a point of attachment.
